(19) United States
(12) Patent Application Publication
(10) Pub. No.: US 2022/0227095 A1
(43) Pub. Date: Jul. 21, 2022

(54) CONTROLLING SHRINKAGE AND MECHANICAL PERFORMANCE OF MULTILAYER SHEET MATERIALS

(71) Applicant: Owens Corning Intellectual Capital, LLC, Toledo, OH (US)

(72) Inventor: Ronald Boisvert, Pickerington, OH (US)

(21) Appl. No.: 17/612,649

(22) PCT Filed: May 29, 2020
(86) PCT No.: PCT/US20/35230

§ 371 Date: Nov. 19, 2021

Related U.S. Application Data
(60) Provisional application No. 62/853,849, filed on May 29, 2019.

(51) Int. Cl. B32B 5/02; B32B 5/26; B32B 7/12; B32B 27/32; B32B 27/12; E02D 31/00; E04D 12/00

(52) U.S. Cl. CPC B32B 5/024; B32B 5/028; B32B 5/275; B32B 5/022; B32B 7/12; B32B 2419/06; B32B 27/12; E02D 31/004; E04D 12/002; B32B 2262/0253; B32B 2262/148; B32B 27/32

(57) ABSTRACT

A sheet material is provided that includes a woven layer having a first side and an opposing second side, the woven layer formed from strand including a polyolefin polymer and a nucleating agent; a first polymeric coating disposed on the first side of the woven layer; and optionally a second polymeric coating disposed on the second side of the woven layer. The sheet material exhibits reduced thermal shrinkage.

### RELATED APPLICATIONS

This application claims priority to and the benefit of U.S. Provisional Application No. 62/853,849, filed May 29, 2019, the entire content of which is incorporated by reference herein.

### FIELD

The present disclosure relates to a multilayer sheet material. In particular, the present disclosure relates to a multilayer sheet material that includes a polymeric woven layer prepared from a polymer composition that includes a nucleating agent.

### BACKGROUND

Geomembranes are low permeability synthetic membrane liners or barriers that are used to control fluid migration. Typical uses for geomembranes include heavy-duty covers and temporary liners for various applications in oil fields, landfills, water containments, remediation, agriculture, etc. The geomembranes are frequently used as artificial pond liners. Geomembranes may be exposed to high temperatures, such as during heat-bonding or when they are exposed to solar energy. Conventional geomembranes may warp or shrink under these circumstances.

In a typical roofing installation using asphalt shingles, an underlayment is first applied to a wood deck of the roof. Conventional roofing underlayments take the form of an asphalt saturated paper which is useful as a waterproofing member. Roofing shingles are applied on top of the underlayment with the seams of adjacent rows positioned in an offset relationship. Presently, there is a trend to produce roofing underlayments out of synthetic materials, such as polymers. While polymeric roofing underlayments have good waterproofing properties, they may shrink or warp when exposed to heat, such as, for example exposure to solar energy or hot asphalt.

Accordingly, there is an unmet need for sheet materials such as geomembranes and roofing underlayments that are resistant to shrinkage due to heat.

### SUMMARY

Disclosed herein are multilayer sheet materials. To illustrate various aspects of the present disclosure, several exemplary embodiments of the multilayer sheet materials are provided.

In one exemplary embodiment, a sheet material is disclosed. The sheet material comprising a woven layer having a first side and an opposing second side, the woven layer comprising a polymeric strand comprising a polyolefin polymer and a nucleating agent; and a first polymeric coating disposed on the first side of the woven layer.

In certain embodiments, the sheet material includes a second polymeric coating disposed on the second side of the woven layer

In certain embodiments, the sheet material further comprises a mesh layer laminated to the first polymeric coating.

In certain embodiments, the mesh layer includes a plurality of first grid lines oriented in first direction and a plurality of second grid lines oriented in a second direction, wherein the first gridlines and the second gridlines form intersections that include peaks.

In certain embodiments, the sheet material further comprises a protective layer disposed on the first polymeric coating.

In certain embodiments, the sheet material further comprises a nonwoven layer disposed on the first polymeric coating.

In certain embodiments, the second polymeric coating includes an outer surface and the sheet material further comprises an adhesive layer on the surface of the second polymeric coating.

In certain embodiments, the adhesive is an asphalt-based adhesive.

In certain embodiments, the sheet material shrinks less than 10% in a linear direction when exposed to 150° C. for 10 minutes.

In certain embodiments, the sheet material shrinks less than 5% in a linear direction when exposed to 150° C. for 10 minutes.

In certain embodiments, the polyolefin polymer is polyethylene.

In certain embodiments, the polyolefin polymer is a high-density polyethylene.

In certain embodiments, the polyolefin polymer of the polymeric strand is a high-density polyethylene, wherein the first polymeric composition includes a linear low-density polyethylene and a low-density polyethylene, and wherein the second polymeric composition includes a linear low-density polyethylene and a low-density polyethylene.

In certain embodiments, the polyolefin polymer is a polypropylene polymer.

In certain embodiments, the polyolefin polymer of the polymeric strand is a polypropylene polymer, wherein the first polymeric coating includes an inner polymeric layer including a polypropylene, a low density polyethylene, a filler, and a pigment; and wherein the first polymeric coating includes an outer layer including polypropylene, low density polyethylene, a filler, a pigment, UV absorbers, and a hindered amine light stabilizer; wherein the second polymeric coating includes an inner polymeric layer including a polypropylene, low density polyethylene, a filler, and a pigment; and wherein the second polymeric coating includes an outer layer including polypropylene, low density polyethylene, a filler, a pigment, UV absorbers, and a hindered amine light stabilizers.

In certain embodiments, the polymeric strand further includes a filler.

In certain embodiments, the polymeric strand further includes a UV light stabilizer and/or UV absorber.

In another exemplary embodiment, a sheet material is disclosed. The sheet material comprising a woven layer having a first side and an opposing second side, the woven layer comprising a polymeric strand comprising a first polyethylene polymer and a nucleating agent; a first polymeric coating comprising a second polyethylene disposed on the first side of the woven layer; a second polymeric coating comprising a third polyethylene disposed on the second side of the woven layer; and a protective layer disposed on the first polymeric coating.

In another exemplary embodiment, a geomembrane installation is disclosed. The geomembrane installation comprising a first sheet material thermal bonded to a second sheet material; wherein the first sheet material and the second sheet material each individual comprise: a woven layer having a first side and an opposing second side, the woven layer comprising a polymeric strand comprising a polyolefin polymer and a nucleating agent; a first polymeric coating disposed on the first side of the woven layer; and a second polymeric coating disposed on the second side of the woven layer.

In another exemplary embodiment, a method of installing a geomembrane is disclosed. The method of installing a geomembrane comprising applying a geomembrane to ground soil to form an open retaining area; and supplying a liquid to the open retaining area; wherein the geomembrane comprises a woven layer having a first side and an opposing second side, the woven layer comprising a polymeric strand comprising a polyolefin polymer and a nucleating agent; a first polymeric coating disposed on the first side of the woven layer; and a second polymeric coating disposed on the second side of the woven layer.

In another exemplary embodiment, a sheet material is disclosed. The sheet material comprising a woven layer having a first side and an opposing second side, the woven layer comprising: a polymeric strand comprising a polypropylene polymer and a nucleating agent; a first polymeric coating comprising a first inner coating and a first outer coating disposed on the first side of the woven layer; a second polymeric coating comprising a second inner coating and a second outer coating disposed on the second side of the woven layer; and a mesh layer disposed on the first polymeric coating.

In another exemplary embodiment, a roofing system is disclosed. The roofing system comprising a roofing deck; a sheet material disposed on the roofing deck; and a roofing material disposed on the sheet material; wherein the sheet material comprises: a woven layer having a first side and an opposing second side, the woven layer comprising: a polymeric strand comprising a polypropylene polymer and a nucleating agent; a first polymeric coating comprising a first inner coating and a first outer coating disposed on the first side of the woven layer; a second polymeric coating comprising a second inner coating and a second outer coating disposed on the second side of the woven layer; and a mesh layer disposed on the first polymeric coating.

Numerous other aspects, advantages, and/or features of the general inventive concepts will become more readily apparent from the following detailed description of exemplary embodiments, from the claims, and from the accompanying drawings being submitted herewith.

### BRIEF DESCRIPTION OF THE DRAWINGS

FIG. 1 is a side elevational view of an exemplary embodiment of a sheet material.

FIG. 2 is a side elevational view of an exemplary embodiment of a sheet material.

FIG. 3 is a side elevational view of an exemplary embodiment of a sheet material.

FIG. 4 is a side elevational view of an exemplary embodiment of a sheet material.

FIG. 5 is a side elevational view of an exemplary embodiment of a self-adhesive sheet material.

FIG. 6 is a schematic diagram of an exemplary embodiment of an apparatus for preparing a polymeric strand, such as a polymeric tape.

FIG. 7 is a top plan view of an exemplary embodiment of the mesh layer of FIG. 3.

FIG. 8 is a side elevational view of an exemplary embodiment of a geomembrane installation.

FIG. 9 is a side elevational view of an exemplary embodiment of a roofing system.

### DETAILED DESCRIPTION

While the general inventive concepts are susceptible of embodiment in many different forms, there are shown in the drawings, and will be described herein in detail, specific embodiments thereof with the understanding that the present disclosure is to be considered as an exemplification of the principles of the general inventive concepts. Accordingly, the general inventive concepts are not intended to be limited to the specific embodiments illustrated herein.

Unless otherwise defined, all technical and scientific terms used herein have the same meaning as commonly understood by one of ordinary skill in the art to which this invention belongs. The terminology used in the description is for describing particular embodiments only and is not intended to be limiting of the general inventive concepts. As used in the description and the appended claims, the singular forms “a,” “an,” and “the” are intended to include the plural forms as well, unless the context clearly indicates otherwise.

The general inventive concepts encompass various embodiments that are directed, at least in part, to a sheet material that includes a coated polymeric woven layer. In one or more embodiments, the polymeric woven layer is sandwiched between two polymer coatings. Advantageously, it has been found that when the polymeric woven layer includes a polymer composition that employs a nucleating agent, the sheet material exhibits reduced shrinkage when exposed to high heat. In one or more embodiments, the sheet material may be impervious to water and/or vapor. The sheet material may be used in construction materials, such as a roofing underlayment, or as a geomembrane.

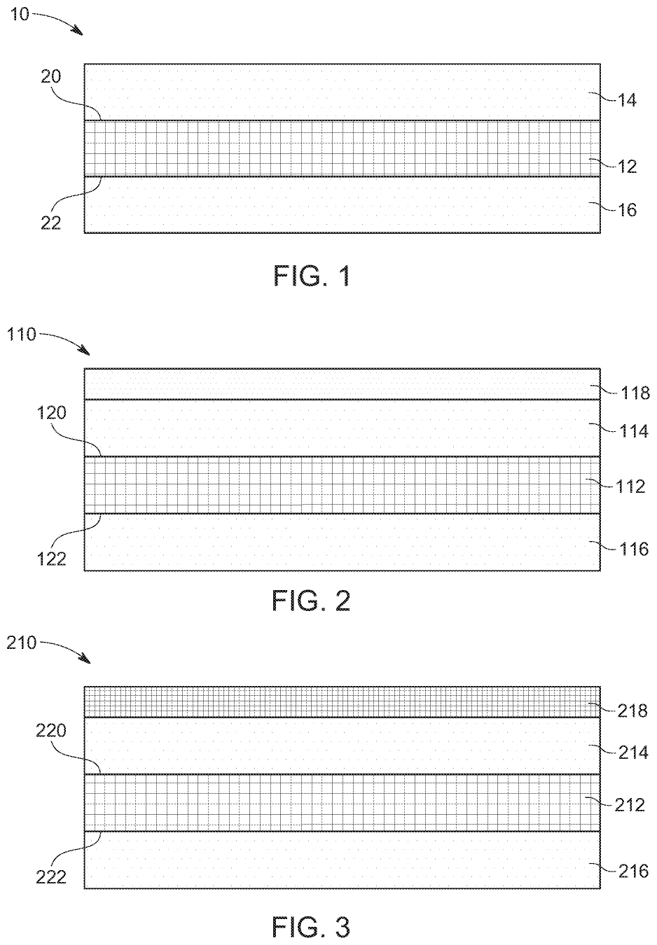

As shown in FIG. 1, a sheet material 10 according to an exemplary embodiment is disclosed. The sheet material 10 includes a polymeric woven layer 12. The polymeric woven layer 12 has a first side 20 and an opposing second side 22. Disposed on the first side 20 of the polymeric woven layer 12 is a first polymer coating 14. In certain embodiments, as described further below, the first polymer coating 14 may include an inner polymer coating and an outer polymer coating. Disposed on the second side 22 of the polymeric woven layer 12 is a second polymer coating 16. In certain embodiments, as described further below, the second polymer coating 16 may include an inner polymer coating and an outer polymer coating.

As shown in FIG. 2, a sheet material 110 according to an exemplary embodiment is disclosed. The sheet material 110 of FIG. 2 is similar to the sheet material 10 of FIG. 1, except the sheet material 110 includes an additional protective coating 118. The sheet material 110 includes a polymeric woven layer 112. The polymeric woven layer 112 has a first side 120 and an opposing second side 122. Disposed on the first side 120 of the polymeric woven layer 112 is a first polymer coating 114. In certain embodiments, as described further below, the first polymer coating 114 may include an inner polymer coating and an outer polymer coating. Disposed on the second side 122 of the polymeric woven layer 112 is a second polymer coating 116. In certain embodiments, as described further below, the second polymer coating 116 may include an inner polymer coating and an outer polymer coating. Disposed on the first polymer coating 114 is the protective coating 118.

As shown in FIG. 3, a sheet material 210 according to an exemplary embodiment is disclosed. The sheet material 210 of FIG. 3 is similar to the sheet material 10 of FIG. 1, except the sheet material 210 includes an additional mesh layer 218. The sheet material 210 includes a polymeric woven layer 212. The polymeric woven layer 212 has a first side 220 and an opposing second side 222. Disposed on the first side 220 of the polymeric woven layer 212 is a first polymer coating 214. In certain embodiments, as described further below, the first polymer coating 214 may include an inner polymer coating and an outer polymer coating. Disposed on the second side 222 of the polymeric woven layer 212 is a second polymer coating 216. In certain embodiments, as described further below, the second polymer coating 216 may include an inner polymer coating and an outer polymer coating. Disposed on the first polymer coating 214 is the mesh layer 218.

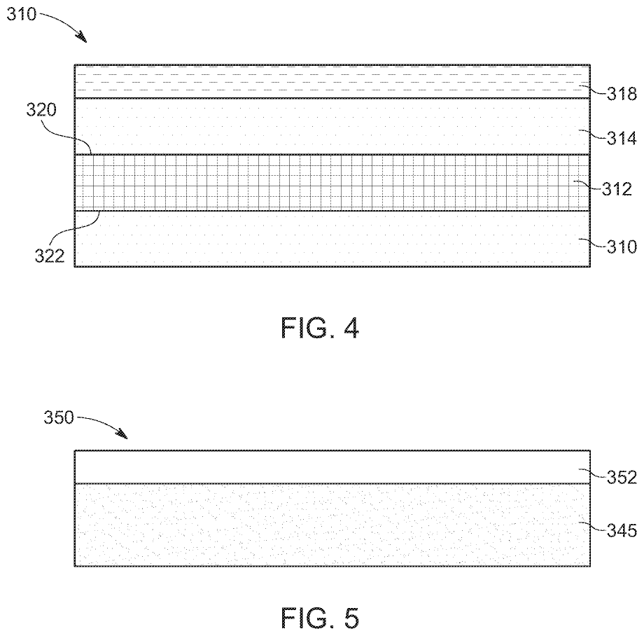

As shown in FIG. 4, a sheet material 310 according to an exemplary embodiment is disclosed. The sheet material 310 of FIG. 4 is similar to the sheet material 10 of FIG. 1, except the sheet material 310 includes an additional nonwoven layer 318. The sheet material 310 includes a polymeric woven layer 312. In one or more embodiments, the nonwoven layer 318 may be prepared from staple or continuous fibers or filaments. Suitable polymers for preparing the fibers or filaments include polyethylenes and/or polypropylenes, such as those described below. In one or more embodiments, the nonwoven layer 318 may include a fiber or filament that includes a thermoplastic elastomer. Thermoplastic elastomers may be used to improve properties such as walkability. In one or more embodiments, the nonwoven layer 318 may be embossed. The polymeric woven layer 312 has a first side 320 and an opposing second side 322. Disposed on the first side 320 of the polymeric woven layer 312 is a first polymer coating 314. In certain embodiments, as described further below, the first polymer coating 314 may include an inner polymer coating and an outer polymer coating. Disposed on the second side 322 of the polymeric woven layer 312 is a second polymer coating 316. In certain embodiments, as described further below, the second polymer coating 316 may include an inner polymer coating and an outer polymer coating. Disposed on the first polymer coating 314 is the nonwoven layer 118.

As shown in FIG. 5, a self-adhesive sheet material 350 according to an exemplary embodiment is disclosed. The self-adhesive sheet material 350 of FIG. 5 includes a sheet material 352 and an adhesive layer 345 adhered to the sheet material 352. The sheet material may be, for example, sheet material 10, 110, 210, or 310. As indicated above the sheet material includes a polymeric woven layer (e.g., polymeric woven layer 12, 112, 212, and 312). While various weavable elements may be used in the polymeric woven layer, such as, for example, polymeric filaments, yarns, or tapes, the term “strands” will be used for simplicity and generality of description. The strands of the polymeric woven layer are prepared using a polymer composition that, for the purposes of this specification, may be referred to as the polymeric strand composition.

As those skilled in the art will appreciate, a woven fabric has two principle directions, the first being the warp direction and the second being the weft direction (also referred to as the fill direction). The warp direction is the length wise or machine direction of the fabric. The weft direction or cross-machine direction is perpendicular to the warp direction. Various weaving patterns may be prepared by alternating the number and placement of warp strands that are above and below the weft strands. Suitable weaving patterns for use in the woven layer include, but are not limited to basic weaves, twill weaves, and satin weaves. In one or more embodiments, the warp and the weft strands of the woven layer are not bonded together via heat, mechanical, or chemical bonding prior to the addition of the subsequent coating layers.

In one or more embodiments, all of the strands in the woven layer have the same polymeric strand composition. In these or other embodiments, the polymeric strand composition may include a polymer and a nucleating agent (and any other optional components). In other embodiments, a first portion of the strands may have a first polymeric strand composition (i.e., with a nucleating agent) and a second portion of the strands may have a second polymeric strand composition (i.e., with or without a nucleating agent). For example, the strands in the weft direction may be prepared with a polymeric strand composition that includes a polymer and a nucleating agent (and any other optional components) and the strands in the warp direction may be prepared without a nucleating agent and include a polymeric strand composition that includes a polymer (and any other optional components). Similarly, the strands in the weft direction may be prepared without a nucleating agent and include a polymeric strand composition that includes a polymer (and any other optional components) and the strands in the warp direction may be prepared with a polymeric strand composition that includes a polymer and a nucleating agent (and any other optional components). Optional components that may be included in the polymeric strand composition include, but are not limited to, one or more fillers, UV absorbers, light stabilizers, antioxidants, thermal stabilizers, pigments, processing aides, carbon black, flame retardants and recycled materials. In certain embodiments, where the polymeric strands include a nucleating agent, the polymeric strands may be referred to as crystalline polymeric strands. Exemplary antioxidants include, but are not limited to, phenolic antioxidants (i.e., sterically hindered phenols). Exemplary thermal stabilizers include, but are not limited to, phosphites and phosphonites.

In one or more embodiments, the polymeric strand composition may include a polyolefin polymer. In one or more embodiments, the polyolefin may be a homopolymer, random copolymer, or a block copolymer. Olefin monomers that may be used in the preparation of a polyolefin include linear, branched, or cyclic alkenes with a single carbon-carbon double bond. In one or more embodiments, the olefin polymer may include mer units derived from the polymerization of one or more monomers selected from the groups consisting of ethylene and C₃ to C₁₂ alpha-olefins, in other embodiments ethylene and C₃ to C₁₀ alpha-olefins, in other embodiments ethylene and C₃ to C₈ alpha-olefins, and in other embodiments ethylene and C₃ to C₆ alpha-olefins. Specific examples of olefin monomers include, but are not limited to, ethylene, propylene, 1-butene, 1-pentene, 1-hexene, 1-heptene, 1-octene, 1-nonene, 1-decene, and 4-methyl-1-pentene.

Specific examples of olefin polymers that may be employed in the polymeric strand composition include, but are not limited to, polyethylene, polypropylene, polybutylene, ethylene-propylene copolymers, and combinations thereof.

In one or more embodiments, the polymeric strand composition may include a polyethylene polymer. Polyethylene polymers include those polymers that have mer units derived from the polymerization of ethylene as their primary component. In one or more embodiments, the polyethylene polymer may be characterized by the weight percent of ethylene mer units, which may be determined using infrared spectroscopy. In one or more embodiments, the polyethylene polymer copolymer may include greater than 50 wt. %, in other embodiments greater than 60 wt. %, in other embodiments greater than 70 wt. %, in other embodiments greater than 80 wt. %, in other embodiments greater than 90 wt. %, in other embodiments greater than 95 wt. %, and in other embodiments greater than 99 wt. % ethylene mer units. In certain embodiments, the polyethylene polymer is a homopolymer.

Specific examples of polyethylenes include linear low-density polyethylenes, low density polyethylenes, medium density polyethylenes, and high density polyethylenes. Those skilled in the art will appreciate that the term “high density polyethylene” denotes a polyethylene composition having a density of 0.941 g/cc or higher; the term “medium density polyethylene” denotes a polyethylene composition having a density of 0.926 g/cc to 0.940 g/cc; and the terms “low density or linear low density polyethylene” denote a polyethylene composition having a density of 0.90 g/cc to 0.925 g/cc. Linear low density polyethylene is an ethylene-based polymer with a density of 0.926 g/cc to 0.940 g/cc that has a low amount of branching and a number of short side chains made, for example, through the copolymerization of short-chain alpha-olefins (e.g., 1-butene, 1-hexene, and 1-octene).

In one or more embodiments, the polymeric strand composition may include a polypropylene polymer. Polypropylene polymers include those polymers that have mer units derived from the polymerization of propylene as their primary component. In one or more embodiments, the polypropylene polymer may be characterized by the weight percent of propylene mer units, which may be determined using infrared spectroscopy. In one or more embodiments, the polypropylene polymer copolymer may include greater than 50 wt. %, in other embodiments greater than 60 wt. %, in other embodiments greater than 70 wt. %, in other embodiments greater than 80 wt. %, in other embodiments greater than 90 wt. %, in other embodiments greater than 95 wt. %, and in other embodiments greater than 99 wt. % propylene mer units. In certain embodiments, the polypropylene polymer is a homopolymer.

In one or more embodiments, the polymeric strand composition may be characterized by the amount of polymer (i.e., the total polymer content) as a weight percent of the polymeric strand composition. In one or more embodiments, the polymeric strand composition may include greater than 75 wt. %, in other embodiments greater than 80 wt. %, in other embodiments greater than 87 wt. %, in other embodiments greater than 90 wt. %, and in other embodiments greater than 99 wt. % polymer. In one or more embodiments, the polymeric strand composition may include from 75 wt. % to 99 wt. %, in other embodiments from 80 wt. % to 95 wt. %, and in other embodiments from 87 wt. % to 92 wt. % polymer.

In one or more embodiments, the polymeric strand composition may include a nucleating agent. Suitable nucleating agents include those compounds that promote crystallinity in the polymers employed in the polymeric strand composition. Advantageously, when at least a portion of the strands in the woven layer are prepared using a polymeric strand composition that includes a nucleating agent, the sheet material has improved heat shrinkage resistance compared to a sheet material that is identical with the exception that it is prepared without a nucleating agent. Suitable nucleating agents include, but are not limited to, phosphate ester salts, sodium benzoate, lithium benzoate, bis(4-tert-butyl-benzoate) aluminum hydroxide, talc, and dibenzylidene sorbitol-based compounds (DBS), calcium carbonate, phosphate ester salts such as sodium phosphate ester salts (e.g., sodium 2,2′-methylene-bis-(4,6-di-tert-butylphenyl)phosphate) and lithium salts (e.g., lithium myristate). Suitable nucleating agents are disclosed in U.S. Pat. Nos. 4,016,118; 4,371,645; 5,049,605; and 7,157,510, which are all incorporated herein, in their entirety, by reference. Examples of commercially available nucleating agents include NA-11, ULTRABALANCE NATURAL 2000, and ULTRABALANCE NATURAL 1001 from Milliken of Spartanburg, S.C.

In one or more embodiments, the polymeric strand composition may be characterized by the amount of nucleating agent as a weight percent of the polymeric strand composition. In one or more embodiments, the polymeric strand composition may include less than 3 wt. %, in other embodiments less than 2.5 wt. %, and in other embodiments less than 2 wt. % nucleating agent. In one or more embodiments, the polymeric strand composition may include greater than 0.5 wt. %, in other embodiments greater than 0.75 wt. %, and in other embodiments greater than 1 wt. % nucleating agent. In one or more embodiments, the polymeric strand composition may include from 0.5 wt. % to 3 wt. %, in other embodiments from 0.75 wt. % to 2.5 wt. %, and in other embodiments from 1 wt. % to 2 wt. % nucleating agent. In certain embodiments, such as where the strands of the woven layer have more than one polymeric strand composition, the polymeric strand composition may not include a nucleating agent.

In one or more embodiments, the polymeric strand composition may include a filler. Suitable fillers for use in the polymeric strand composition include, but are not limited to, calcium carbonate, talc, mica, and carbon black. In one or more embodiments, the polymeric strand composition may be characterized by the amount of filler as a weight percent of the polymeric strand composition. In one or more embodiments, the polymeric strand composition may include less than 25 wt. %, in other embodiments less than 15 wt. %, and in other embodiments less than 5 wt. % filler. In one or more embodiments, the polymeric strand composition may include greater than 1 wt. %, in other embodiments greater than 5 wt. %, and in other embodiments greater than 10 wt. % filler. In one or more embodiments, the polymeric strand composition may include from 1 wt. % to 25 wt. %, in other embodiments from 5 wt. % to 15 wt. %, and in other embodiments from 5 wt. % to 10 wt. % filler.

In one or more embodiments, the filler for use in the polymeric strand composition may be included in a masterbatch formulation. In these or other embodiments, the filler masterbatch may include a filler and a polymer. Suitable polymers for use in the filler masterbatch include polyolefins, as described above. Exemplary polyolefin polymers that may be included in the filler masterbatch include polypropylene polymers and polyethylene polymers, such as LLDPE. In one or more endowments, the filler masterbatch may include 50 wt. % to 90 wt. % filler, in other embodiments 70 wt. % to 85 wt. % filler, and in other embodiments 75 wt. % to 82 wt. % filler. In these or other embodiments, the filler masterbatch may include 10 wt. % to 50 wt. % polymer, in other embodiments 15 wt. % to 30 wt. % polymer, and in other embodiments 18 wt. % to 25 wt. % polymer.

In one or more embodiments, the polymeric strand composition may include an ultraviolet (UV) light stabilizer and/or a UV absorber. Suitable UV light stabilizers for use in the polymeric strand composition include, but are not limited to, hindered amine light stabilizers (“HALS”), nickel quenchers, and combinations thereof. Suitable UV light absorbers for use in the polymeric strand composition include, but are not limited to, benzophenones, benzotriazoles, and combinations thereof.

In one or more embodiments, the polymeric strand composition may be characterized by the amount of UV light stabilizer and/or UV absorber as a weight percent of the polymeric strand composition. In one or more embodiments, the polymeric strand composition may include less than 1.5 wt. %, in other embodiments less than 1 wt. %, in other embodiments less than 0.5 wt. %, and in other embodiments less than 0.3 wt. % UV light stabilizer and/or UV absorber. In one or more embodiments, the polymeric strand composition may include greater than 0.05 wt. %, in other embodiments greater than 0.1 wt. %, in other embodiments greater than 0.12 wt. %, and in other embodiments greater than 0.15 wt. % UV light stabilizer and/or UV absorber. In one or more embodiments, the polymeric strand composition may include from 0.05 wt. % to 1.5 wt. %, in other embodiments from 0.1 wt. % to 1 wt. %, in other embodiments from 0.12 wt. % to 0.5 wt. %, and in other embodiments from 0.15 wt. % to 0.3 wt. % UV light stabilizer and/or UV absorber.

In one or more embodiments, the UV light stabilizer and/or UV absorber for use in the polymeric strand composition may be included in masterbatch formulation. In these or other embodiments, the UV masterbatch may include a UV light stabilizer and/or UV absorber and a polymer. Suitable polymers for use in the UV masterbatch include polyolefins as described above. Exemplary polyolefin polymers that may be included in the UV masterbatch include polypropylene polymers and polyethylene polymers such as LLDPE. In one or more endowments, the UV masterbatch may include 5 wt. % to 30 wt. % UV light stabilizer and/or UV absorber, in other embodiments 10 wt. % to 28 wt. % UV light stabilizer and/or UV absorber, and in other embodiments 15 wt. % to 25 wt. % UV light stabilizer and/or UV absorber. In these or other embodiments, the UV masterbatch may include 70 wt. % to 95 wt. % polymer, in other embodiments 72 wt. % to 90 wt. % polymer, and in other embodiments 75 wt. % to 85 wt. % polymer.

In one or more embodiments, the individual components of the polymeric strand composition (including the nucleating agent) may be combined, heated, and then extruded to form, for example, a film, fiber, or filament which, in turn may be used to prepare the strands for the woven layer. In one or more embodiments, the inclusion of the nucleating agent promotes the crystallization of the polymer in the polymeric strand composition as it is extruded. In certain embodiments, where the polymeric strands are prepared with a nucleating agent, the process of preparing the polymeric strand in the presence of a nucleating agent increases the crystalline structure in the polymers of the polymeric strand composition. The nucleating agent may also decreases the crystallite size and increase the melt point of the polymeric strand composition.

In one or more embodiments, the woven layer may be characterized by the number of strands per centimeter. In one or more embodiments, the woven layer has from 1 to 8 strands per cm, in other embodiments from 1.25 to 6 strands per cm, and in other embodiments from 1.5 to 4 strands per cm.

As indicated above, the woven layer may be prepared using tapes. In these or other embodiments, the tapes may be slit-film tapes. Slit-film tapes may be prepared by combining the individual components of the polymeric strand composition (including, in some embodiments, the nucleating agent), heating the components, and then extruding the composition to form a film. The film is then sliced into individual tapes. After the film is sliced into tapes, it may optionally be processed. Processing may include stretching the tapes in a stretching oven, annealing the tapes, or a combination thereof. Advantageously, the slit film tapes that are prepared with a nucleating agent have low shrinkage and good mechanical performance by taking advantage of the crystallization behavior observed in the presence of the nucleating agent.

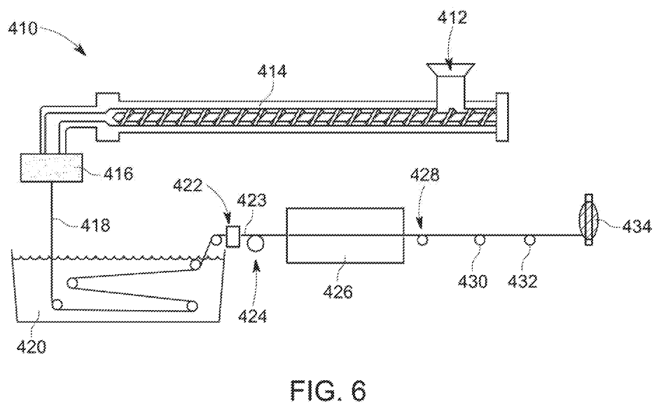

As shown in FIG. 6, a schematic diagram of an exemplary embodiment of an apparatus for preparing a polymeric strand, such as a polymeric tape 410, is provided. The apparatus 410 includes a hopper or polymer feed 412, where the components of the polymeric strand composition may be added individually or simultaneously. After the polymeric strand composition is feed into the hopper or polymer feed 412 it enters a screw extruder 416 where the polymeric strand composition may be heated and mixed. The polymeric strand composition exits the screw extruder 416 and enter a die 416 that forms film 418. After film formation, the film 418 enters a water tank 420 for quenching. The distance between the water in the water tank 420 and the die 416 is about 25 mm. The water in the water tank may be at a temperature of about 25° C. The film 418 exist the water tank 420 and the film 418 is sliced into individual tapes 423 at slicer 422. The tapes 423 pass a speed isolation roll 424 and are then sent into an oven 426. Oven 426 is shown without rollers and the tape passes through the oven completely unsupported. In one or more embodiments, oven 426 may include rollers to extend the travel time of tapes 423 in the oven 426. Upon leaving the oven 426, the tapes 423 are rolled on one or more stretch rollers 428 (e.g., 1, 2, or 4 rollers). Stretch rollers 428 are running at a higher revolution per minute than speed isolation roller 424 causing the tape to stretch as it passes through the oven 426. After the stretch rollers 428, the tapes 423 are annealed on one or more annealing rollers 430 (e.g., 1, 2, or 4 rollers) where heat is applied to anneal the tapes 423. The annealing rollers 430 may be rotated at equal or lower revolution per minute than isolation roller 424. In certain embodiments, shrinkage that tapes 423 may take place as the tape passes over the annealing rollers 430. After the tapes are annealed, they may be then be cooled on one or more cooling rollers 432 (e.g., 1, 2, or 4 rollers). Suitable temperatures for the cooling roller may be less than ambient temperature, for example 15° C. The annealing roller 430 and the cooling roller 432 may collectively be referred to as the fixing rollers. Similar to the annealing roller 430, the cooling roller 432 may be turned at an equal or lower speed than the stretch rollers 428. After leaving the cooling roller 432, the tapes may be wound on a bobbin 434. Suitable rollers for use in the tape making process include, for example, Godet rollers.

In one or more embodiments, the process for preparing the slit tape may be characterized by the roller temperature for the annealing roller. In one or more embodiments, such as when the slit film tapes are prepared using polypropylene, the annealing roller may have a temperature in the range of 160° C. to 180° C., in other embodiments 165° C. to 175° C., and in other embodiments 168° C. to 172° C. In other embodiments, such as when the slit film tapes are prepared using polyethylene, the annealing roller may have a temperature in the range of 130° C. to 135° C., in other embodiments 131° C. to 134.5° C., and in other embodiments 132° C. to 134° C.

In one or more embodiments, the process for preparing the slit tape may be characterized by the oven temperature. In one or more embodiments, such as when the slit film tapes are prepared using polypropylene, the oven may have a temperature in the range of 130° C. to 170° C., in other embodiments 150° C. to 160° C., and in other embodiments 154° C. to 156° C. In one or more embodiments, such as when the slit film tapes are prepared using polyethylene, the oven may have a temperature in the range of 115° C. to 120° C., in other embodiments 115.5° C. to 119.5° C., and in other embodiments 116° C. to 119° C.

In one or more embodiments, the process for preparing the slit tape may have a decrease in roller speed between the stretch rollers 428 and the fixing rollers. In one or more embodiments, the decrease in roller speed may be in the range of 6% to 35%, in other embodiments 8% to 28%, and in other embodiments 10% to 26%.

In certain embodiments, the tapes employed in the warp direction of the woven layer (“warp tapes”) may be a different size in at least one dimension (e.g., width and/or thickness) than the tapes employed in the weft direction of the woven layer (“weft tapes”). In other embodiments, the warp tapes and the weft tapes are the same size. In one or more embodiments, the tapes may be characterized by the width of the tape. In one or more embodiments, the tapes may have a width in the range of 1 mm to 8 mm, in other embodiments the tapes may have a width in the range of 2 mm to 7 mm, and in other embodiments the tapes may have a width in the range of 2.5 mm to 5.5 mm.

In certain embodiments, where the warp tape and the weft tape are different sizes, a first tape (either the warp tape or the weft tape) may have a width in the range of 1 mm to 4 mm, in other embodiments in the range of 2 mm to 3.5 mm, and in other embodiments in the range of 2.5 mm to 3 mm. In these or other embodiments, a second tape (the warp tape or the weft tape not selected as the first tape) may have a width in the range of 3 mm to 8 mm, in other embodiments the tapes may have a width in the range of 4 mm to about 7 mm, and in other embodiments the tapes may have a width in the range of 4.5 mm to about 5.5 mm. Exemplary tape widths include but are not limited to, 2.5 mm, 3.1 mm, 4.5 mm, 5.1 mm, and 6.2 mm.

In one or more embodiments, the tapes may be characterized by a linear density in grams per 10 kilometers (“deci-tex”). In one or more embodiments, the tapes may have a deci-tex in the range of 500 to 2850, in other embodiments in the range of 600 to 2,400, and in other embodiments in the range of 750 to 2,250.

In certain embodiments, where the warp tape and the weft tape are different sizes. In one or more embodiments first tape (either the warp tape or the weft tape) may have a deci-tex in the range of 500 to 1950, in other embodiments in the range of 600 to 1650, and in other embodiments in the range of 750 to 1260. In these or other embodiments, a second tape (the warp tape or the weft tape not selected as the first tape) may have a deci-tex in the range of 1,500 to 2,850, in other embodiments in the range of 1,700 to 2,400, and in other embodiments in the range of 1,800 to 2,250.

As indicated above, the sheet material includes a first polymeric coating and a second polymeric coating. The compositions of the of the first polymeric coating and the second coating may be referred to as the first polymeric coating composition and the second polymeric coating composition, respectfully. In one or more embodiments, the first polymeric coating composition and the second polymeric coating composition are the same. In other embodiments, the first polymeric coating composition and the second polymeric coating composition are different.

In one or more embodiments, the sheet material may include more than one polymeric coating composition on a single side of the polymeric woven layer. In one or more embodiments, the sheet material may include more than one polymeric coating composition on the first side of the polymeric woven layer, on the second side of the polymeric woven layer, or on both the first and second sides of the polymeric woven layer. In these or other embodiments, the sheet material may include a polymeric coating layer adjacent to the woven layer, which may be referred to as an inner polymeric layer, and another polymeric coating layer disposed on the inner polymeric layer, which may be referred to as an outer polymeric coating layer. The inner polymeric coating layer and the outer polymeric coating layer may be formed, for example, by co-extruding the inner polymeric coating composition and outer polymeric coating composition onto the woven layer. The inner polymeric coating layer and the outer polymeric coating layer may have the same or different polymeric coating compositions.

For brevity of description, the first polymeric coating composition, the second polymeric coating composition, the inner polymeric composition, and the outer polymeric composition will each be generally described as a “polymeric coating composition.” Accordingly, it should be understood that reference to the term polymeric coating composition may refer to the first polymeric coating composition, the second polymeric coating composition, the inner polymeric composition, and/or the outer polymeric composition.

Suitable polymers for use in the polymeric coating composition include various thermoplastic elastomers. In one or more embodiments, the polymeric coating composition may include a polyolefin as described above. In addition to the polymer, optional components of the polymeric coating composition may include, but are not limited to, one or more pigments, recycled materials, fillers, UV absorbers, hindered amine light stabilizers (HALS), anti-slip additives, antioxidants, thermal stabilizers, processing aides, flame retardants, and carbon black.

Specific examples of olefin polymers that may be employed in the polymeric coating composition include, but are not limited to, polyethylene, polypropylene, polybutylene, blends of polyethylene and polypropylene, and ethylene-propylene copolymers.

In one or more embodiments, the polymeric coating composition may be characterized by the amount of polymer (i.e., the total polymer content) as a weight percent of polymeric coating composition. In one or more embodiments, the polymeric coating composition may include greater than 75 wt. %, in other embodiments greater than 85 wt. %, in other embodiments greater than 90 wt. %, in other embodiments greater than 93 wt. %, and in other embodiments greater than 99 wt. % polymer. In one or more embodiments, polymeric coating composition may include from 75 wt. % to 99 wt. %, in other embodiments from 85 wt. % to 98 wt. %, and in other embodiments from 93 wt. % to 98 wt. % polymer.

In one or more embodiments, the polymeric coating composition may include a filler. Suitable fillers for use in the polymeric coating composition include, but are not limited to, calcium carbonate, talc, mica, and carbon black. In one or more embodiments, the polymeric coating composition may be characterized by the amount of filler as a weight percent of the polymeric coating composition. In one or more embodiments, the polymeric coating composition may include less than 15 wt. %, in other embodiments less than 12 wt. %, and in other embodiments less than 10 wt. % filler. In one or more embodiments, the polymeric coating composition may include greater than 1 wt. %, in other embodiments greater than 3 wt. %, and in other embodiments greater than 5 wt. % filler. In one or more embodiments, the polymeric coating composition may include from 1 wt. % to 15 wt. %, in other embodiments from 3 wt. % to 12 wt. %, and in other embodiments from 5 wt. % to 10 wt. % filler.

In one or more embodiments, the polymeric coating composition may include a nucleating agent. In other embodiments, the polymeric coating composition does not include a nucleating agent. Advantageously, it has been found that inclusion of the nucleating agent in at least a portion of the strands of the polymeric woven layer improves heat shrinkage resistance in embodiments that do not include a nucleating agent in the polymeric coating composition.

In one or more embodiments, the first polymeric coating may include a combination of high-density polyethylene and low-density polyethylene. In these or other embodiments, the second polymeric coating may include a combination of linear low-density polyethylene and low-density polyethylene. In these or other embodiments, the first polymeric coating and the second polymeric coating may include carbon black.

In one or more embodiments, where the sheet material includes an inner polymeric layer, the inner polymeric layer may include polypropylene, low density polyethylene, a filler, a pigment, and optionally recycled sheet material. In these or other embodiments, where the sheet material includes an outer polymeric layer, the outer polymeric may include polypropylene, low density polyethylene, a filler, a pigment, UV absorbers, a hindered amine light stabilizers (HALS), and an anti-slip additive (for example, amorphous polypropylene or a thermoplastic elastomer).

The polymeric coating layer may be formed in and/or on the sheet material in a wide variety of different ways. For example, the polymeric coating composition may be applied to during the construction of the sheet material to form the polymeric coating layer by extrusion coating, extrusion lamination, air spraying, dip coating, knife coating, roll coating. The polymeric coating layer may also be applied as a preformed film by heat pressing, calendaring, needling, ultrasonic bonding or welding, adhesives, tie layers, and/or point bonding. The polymeric coating layer may also be bonded to one or more of the other layers by chemical bonding, mechanical bonding and/or thermal bonding.

In one or more embodiments, the coating may be characterized by an area weight in grams per square meters (“gsm”). In one or more embodiments, the coating may have an area weight in the range of 18 gsm to 100 gsm, in other embodiments the coating may have an area weight in the range of 28 gsm to 40 gsm, and in other embodiments the coating may have an area weight in the range of 30 gsm to 48 gsm.

As described herein, the sheet material (e.g., sheet material 110) may include a protective coating layer. The protective layer may include a polyolefin polymer as described above. In addition to the polymer, optional components of the protective coating composition may include, but are not limited to, one or more pigments, recycled materials, fillers, UV absorbers, hindered amine light stabilizers (HALS), anti-slip additives, antioxidants, thermal stabilizers, processing aides, and carbon black.

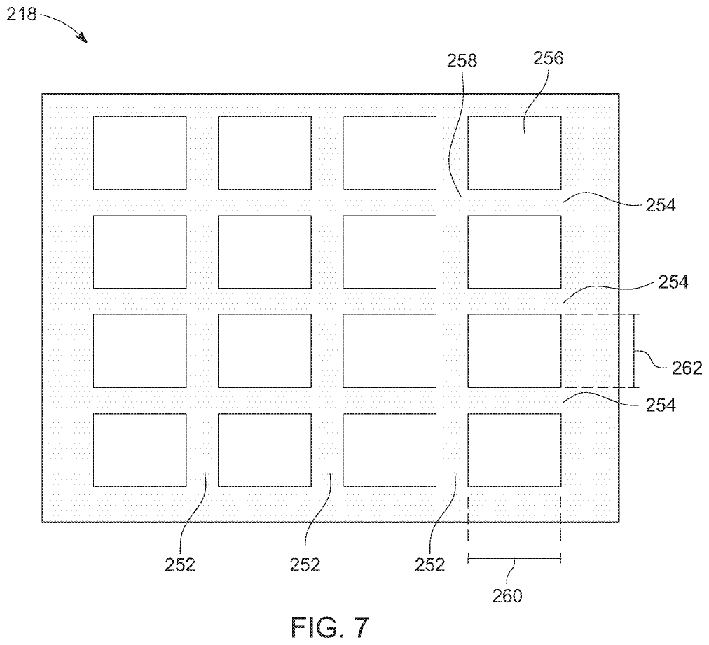

As described herein, the sheet material (e.g., sheet material 210) may include a mesh layer 218. FIG. 7 illustrates a top view of the mesh layer 218. The mesh layer 218 includes an open-grid formation formed by a plurality of grid lines 252 in a first direction and a plurality of grid lines 254 in a second direction. The grid lines 252 and the of grid lines in 254 form a plurality of openings 256 and intersections 258. Each intersection 258 has a peak that extends higher than the grid lines 252, 258 (i.e., the non-intersection area of the grid lines). Each opening 256 may be defined by a width 260 and a length 262.

The mesh layer 218 may be prepare from a composition (which may be referred to as the mesh layer composition) that includes a polyolefin polymer as described above. In addition to the polyolefin polymer, optional components of the mesh layer composition may include, but are not limited to, one or more pigments, fillers, UV absorbers, hindered amine light stabilizers (HALS), anti-slip additives, antioxidants, thermal stabilizers, pigments, processing aides, carbon black, and recycled materials.

Specific examples of olefin polymers that may be employed in the mesh layer composition include, but are not limited to, polyethylene, polypropylene, polybutylene, blends of polyethylene and polypropylene, and ethylene-propylene copolymers. In one or more embodiments, the mesh layer composition may include a filler. Suitable fillers for use in the mesh layer composition include, but are not limited to, calcium carbonate, talc, mica, and carbon black.

In one or more embodiments, the mesh layer 218 may by formed by extruding a biaxial oriented mesh layer composition and then stretching the layer in both the machine and the cross directions until a mesh with a desired opening size is formed. The mesh layer may then be laminated to the sheet material by the first coating composition. Methods of preparing a mesh layer are disclosed in U.S. Pat. No. 6,925,766, which is incorporated herein, in its entirety, by reference.

In one or more embodiments, the grid lines of the mesh layer may have a height (i.e., the non-intersection section of the grid lines) that is in the range of 0.15 mm to 0.3 mm, in other embodiments in the range of 0.18 mm to 0.28 mm, and in other embodiments in the range of 0.2 mm to 0.25 mm. In one or more embodiments, the intersections of the mesh layer 218 may have a height that is in the range of 0.5 mm to 0.85 mm, in other embodiments in the range of 0.55 mm to 0.85 mm, and in other embodiments in the range of 0.6 mm to 0.75 mm.

In one or more , the openings 250 of the mesh layer 218 may have a width 260 in the range of 0.5 cm to 1 cm, in other embodiments in the range of 0.55 cm to 0.9 cm, and in other embodiments in the range of 0.6 cm to 0.8 cm. In one or more embodiments, the opening of the mesh layer 218 may have a length in the range of 0.5 cm to 1 cm, in other embodiments in the range of 0.55 cm to 0.9 cm, and in other embodiments in the range of 0.6 cm to 0.8 cm. In some embodiments, the width 260 of the openings 256 equals the length 262 of the openings 416.

As shown in FIG. 5, the sheet material may include an adhesive. For example, the sheet material (e.g., 10, 110, 210, 310) may include an adhesive on the surface of the second polymeric coating (e.g., 16, 116, 216, 316). The adhesive may be included in the form of one or more strips, a pattern of discrete applications, or a continuous coating. Suitable adhesives for use in the adhesive coating include asphalt-based adhesives. Asphalt-based adhesives include asphalt as the primary adhesion promoting constituent of the adhesive composition. In addition to asphalt, an asphalt-based adhesive composition may include polymers, waxes, fillers, oils, antioxidants, and combinations thereof. An optional release liner may be included adjacent to the adhesive. The optional release liner may be used to prevent the adhesive from sticking during storage or shipping. Prior to the use of the sheet material, the release liner may be removed, and the sheet material may be installed.

The asphalt-based adhesive composition may be applied to the sheet material in any suitable manner. In one or more embodiments, the asphalt-based adhesive composition is applied to the sheet material as a hot, melted asphalt-based adhesive composition. In these or other embodiments, the temperature of asphalt-based adhesive composition may be in the range of 160° C. to 182° C. Suitable methods for applying the asphalt-based adhesive composition to the sheet material include, but are not limited to, spray coating or roll coating. The use of asphalt-based adhesives in conventional polymeric sheet materials is limited, because the application of hot, melted asphalt causes conventional polymeric sheet materials to shrink. Advantageously, it has been found that inclusion of the nucleating agent in at least a portion of the strands of the polymeric woven layer improves heat shrinkage resistance when the sheet material (e.g., 10, 110, 210, or 310) is exposed to hot, melted asphalt.

In one or more embodiments, the sheet material may be characterized by a resistance to heat shrinkage. Heat shrinkage resistance may be determined by exposing a sample (e.g., an amount of sheet material ranging from 12″×12″ to 4″×4″ or a single polymeric strand, such as, a tape). The sample is exposed to temperatures of 150° C. in an oven, for 10 minutes.

In one or more embodiments, the sample of sheet material shrinks less than 10%, in other embodiments less than 9%, in other embodiments less than 8%, in other embodiments less than 7%, in other embodiments less than 6%, in other embodiments less than 5%, in other embodiments less than 4% in a linear direction when exposed to 150° C. for 10 minutes. In one or more embodiments, the sample of sheet material shrinks in the range of 10% to 3%, in other embodiments in the range of 9% to 3.5%, in other embodiments in the range of 8% to 4%, and in other embodiments in the range of 7% to 4.5% when exposed to 150° C. for 10 minutes.

In one or more embodiments, the sample of polymeric strand shrinks less than 10%, in other embodiments less than 9%, in other embodiments less than 8%, in other embodiments less than 7%, in other embodiments less than 6%, in other embodiments less than 5%, in other embodiments less than 4% in a linear direction when exposed to 150° C. for 10 minutes. In one or more embodiments, the sample of polymeric strand shrinks in the range of 10% to 3%, in other embodiments in the range of 9% to 3.5%, in other embodiments in the range of 8% to 4%, and in other embodiments in the range of 7% to 4.5% when exposed to 150° C. for 10 minutes.

In one or more embodiments, the sheet material may be characterized by a resistance to heat shrinkage. Heat shrinkage resistance may be determined by submerging a sample (e.g., an amount of sheet material ranging from 12″×12″ to 4″×4″ or a single polymeric strand, such as, a tape) in water at a temperature of 95° C., for 10 minutes. In one or more embodiments, the sample of sheet material shrinks less than 3%, in other embodiments less than 2.5%, in other embodiments less than 2%, in other embodiments less than 1.5%, in other embodiments less than 1%, in other embodiments less than 0.5% in a linear direction when submerged in water at 95° C. for 10 minutes. In one or more embodiments, the sample of polymeric strand shrinks less than 3%, in other embodiments less than 2.5%, in other embodiments less than 2%, in other embodiments less than 1.5%, in other embodiments less than 1%, in other embodiments less than 0.5% in a linear direction when submerged in water at 95° C. for 10 minutes.

In one or more embodiments, the sheet material (e.g., 10, 110, 210, and 310) may be used as a geomembrane. Geomembranes may be used as liners for various application such as, for example, oil fields, landfills, water containments, remediation, and agriculture.

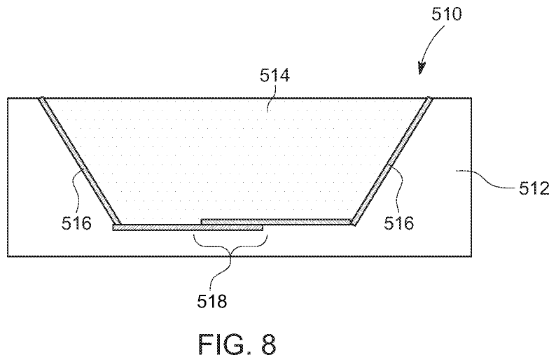

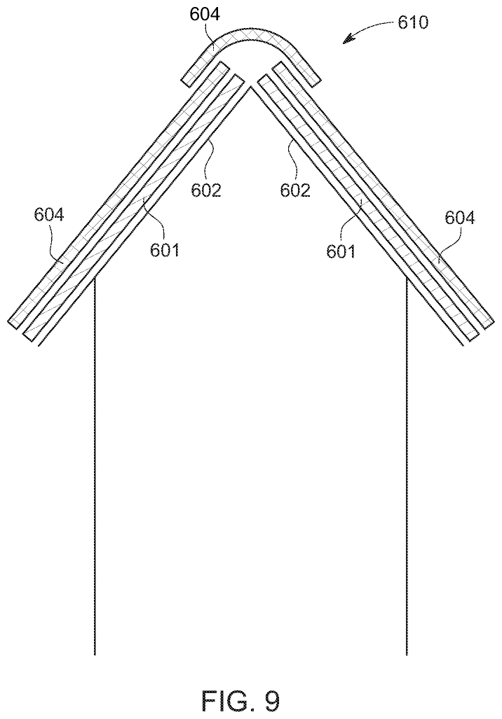

FIG. 8 illustrates an exemplary geomembrane installation 510. The geomembrane installation 510 includes a geomembrane 516 installed between the ground soil 512 and a liquid 514. Due to the low permeability of the geomembrane 516, the liquid 514 remains separated from the ground soil 512. The geomembrane 516 may include a seam 518, where two or more geomembranes are thermal-bonded to form one single geomembrane. In one or more embodiments, the liquid may include water. Liquid 514 may be selected from one of more potable water, reserve water, pond, waste liquids, sewage, brine solutions.

As indicated above, the sheet materials, such as geomembranes, may be thermal-bonded. Thermal bonding, which is also referred to as heat welding, includes using heat to bond two overlapping edges of sheet materials together to form a larger sheet material. In these or other embodiments, the overlap between a first and a second geomembrane may be in the range of 2.5 to 13 cm. The sheet materials may be thermal bonded at temperatures in the range of 350° C. to 400° C. Thermal bonding of the sheet material may be performed using, for example, a thermal fusion welder.

In one or more embodiments, the sheet material may be used in a roofing system.

FIG. 9 illustrates a building 610 that uses a sheet material 601 (e.g., the sheet material 10, 110, 210, or 310) as a roofing underlayment. The building 610 includes a roof deck 602. The sheet material 601 is disposed on the roof deck 602, for example, the sheet material 601 can be attached to the roof deck 602 with nails or staples. Alternatively, in embodiments where the sheet material 601 includes an adhesive, the adhesive may be used to secure the sheet material 601 to the roof deck 602. Roofing material 604, such as shingles, is attached to the roof deck 602, with the sheet material 601 disposed between the roofing material 604 and the roof deck 602. The sheet material 601 is configured to prevent liquid water that may come into contact with the sheet material from passing through the sheet material 601 and reaching the roof deck 602.

Any of the sheet materials as described above may be used as a roofing underlayment. In certain embodiments, a sheet material having a mesh layer, (e.g., sheet material 210) may be used as a roofing underlayment in a roofing system. In these or other embodiments, the sheet material 601 may be laid on the roofing deck so that the second polymer coating layer is facing the roofing deck (and optionally any adhesive layers) and the mesh layer is facing away from the roofing deck. Advantageously, the mesh layer may provide increased traction for walking during roofing installation.

### EXAMPLES

### Example 1

Slit film tapes were prepared according to the process described above in reference to FIG. 6. The process parameters for the individual samples are provided in Table 1. Sample 1 is a comparative example that includes 90 wt. % virgin polypropylene and 10 wt. % calcium carbonate masterbatch. Samples with an additive level listed as 1 wt. % include 89.2 wt. % virgin polypropylene, 9.9 wt. % calcium carbonate masterbatch, and 0.9 wt. % of the nucleating agent Milliken UBN 2000. Samples with an additive level listed as 2 wt. % include 89.4 wt. % virgin polypropylene, 9.8 wt. % calcium carbonate masterbatch, and 1.8 wt. % of the nucleating agent Milliken UBN 2000. The calcium carbonate masterbatch includes 78-82 wt. % calcium carbonate with the remainder being polyethylene.

TABLE 1
Slit Film Tape Process Parameters

| | Additive | Line | Oven | Annealing | Stretch | | |
|---|---|---|---|---|---|---|---|
| | Level | Speed | Temp | Godet Roll | Stretch | Fixing | % |
| No. | (wt. %) | (m/min) | (° C.) | (° C.) | (m/min) | (m/min) | Decrease |
| 1 | 0 | — | — | — | — | — | — |
| 2 | 1 | 240 | 130 | 140 | 241.1 | 217.5 | 9.8 |
| 3 | 1 | 240 | 140 | 150 | 241.1 | 217.5 | 9.8 |
| 4 | 1 | 240 | 150 | 160 | 241.1 | 217.5 | 9.8 |
| 5 | 1 | 240 | 160 | 170 | 240.0 | 179.0 | 25.4 |
| 6 | 2 | 170 | 155 | 170 | 170.4 | 135.9 | 20.2 |
| 7 | 2 | 170 | 155 | 170 | 170.1 | 135.9 | 20.1 |
| 8 | 2 | 170 | 155 | 170 | 170.4 | 139.3 | 18.3 |
| 9 | 2 | 150 | 155 | 170 | 150.2 | 122.6 | 18.4 |
| 10 | 2 | 125 | 155 | 170 | 150.2 | 122.6 | 18.4 |
| 11 | 2 | 200 | 155 | 170 | 200.5 | 164.0 | 18.2 |
| 12 | 1 | 170 | 160 | 170 | 170.7 | 126.3 | 26.0 |

The properties of the slit film tapes are provided in Table 2. Testrite data was prepared using a heat shrinkage tester available from Testrite using a 9 grams weight placed on the tape.

Oven data was prepared by measuring a sample before and after it is exposed to temperatures of 150° C. in an oven for 10 minute and determining the percent change. Strength data was determined under parameters set out in ASTM D882-18. Elongation data was determined under parameters set out in ASTM D882-18. The properties of the individual slit film tapes are provided in Table 2.

TABLE 2
Slit Film Properties

| | | High Temperature | | | | | |
|---|---|---|---|---|---|---|---|
| | | Shrinkage | | | | | |
| | | Testrite | Oven | Strength | | Elongation | |
| No. | Decitex | Data | Data | kgf | SD | % | SD |
| 1 | 1260 | 23.8 | 27.7 | 4.06 | 0.56 | 17.35 | 4.24 |
| 2 | 1242 | 23.9 | 33.7 | 5.35 | 0.55 | 26.20 | 6.44 |
| 3 | 1230 | >24 | 29.6 | 4.69 | 0.76 | 21.70 | 7.17 |
| 4 | 1239 | >24 | 21.4 | 4.11 | 0.41 | 17.51 | 3.92 |
| 5 | 1344 | 5.0 | 4.6 | 3.37 | 0.51 | 43.94 | 11.68 |
| 6 | 1847 | 5.3 | 5.8 | 4.63 | 0.36 | 30.18 | 2.61 |
| 7 | 1377 | 5.5 | 6.0 | 2.54 | 0.27 | 19.62 | 1.93 |
| 8 | 1318 | 6.1 | 6.0 | 3.67 | 0.16 | 26.23 | 1.57 |
| 9 | 1302 | 6.8 | 5.7 | 3.41 | 0.64 | 27.45 | 8.53 |
| 10 | 1281 | 5.3 | 5.2 | 3.62 | 0.16 | 37.63 | 2.70 |
| 11 | 1327 | 6.2 | 6.2 | 4.35 | 0.49 | 30.68 | 5.00 |
| 12 | 1252 | 3.9 | 3.7 | 2.89 | 0.74 | 44.70 | 17.93 |

### Example 2

Polymeric sheets were prepared by coating woven polymeric tapes on both sides with an extrusion coating of polypropylene, where each coating is in the amount of 30 gsm. The woven polymeric tapes, or scrim, has a weight of 58.3 gsm and a PIC Count of 10×4.7 (MD×CD). The tapes in the machine direction have a decitex target of 888 and a width of 2.5 mm. The tapes in the cross direction have a decitex target of 1260 and a width of 5.1 mm.

The tapes listed as “standard composition” include 88.4 wt. % virgin polypropylene, 9.8 wt. % calcium carbonate masterbatch, and 1.0 wt. % UV masterbatch. The tapes were listed as “low shrink” include 87.4 wt. % virgin polypropylene, 9.8 wt. % calcium carbonate masterbatch, 1.8 wt. % nucleating agent, and 1.0 wt. % UV masterbatch. The UV masterbatch includes 20% active ingredient and the remainder is polyethylene. Specifics of the polymeric sheets are provided in Tables 3, 4, and 5. Facer high temperature shrinkage was tested using a temperature of 150° C.

TABLE 3
Polymeric Sheet Samples 1

| | Tape | | | | | |
|---|---|---|---|---|---|---|
| | Machine Direction | | Cross Machine Direction | | Facer High | |
| | | Average | | Average | Temperature | |
| | | High | | High | Shrinkage | |
| | | Temp | | Temp | (%) | |
| | | Shrinkage | | Shrinkage | MD | CD |
| No. | Composition | (%) | Composition | (%) | (%) | (%) |
| 1 | Standard | ~25 | Standard | ~25 | 28.7 | 26.6 |
| 2 | Standard | ~25 | Standard | ~25 | 22.2 | 18.3 |
| 3 | Standard | ~25 | Standard | ~25 | 23.1 | 21.4 |
| 4 | Standard | ~25 | Standard | ~25 | 24.3 | 22.4 |
| 5 | Standard | ~25 | Standard | ~25 | 24.9 | 24.1 |
| | | | | Ave= | 24.6 | 22.6 |

TABLE 4
Polymeric Sheet Samples 2

| | Tape | | | | | |
|---|---|---|---|---|---|---|
| | Machine Direction | | Cross Machine Direction | | Facer High | |
| | | Average | | Average | Temperature | |
| | | High | | High | Shrinkage | |
| | | Temp | | Temp | (%) | |
| | | Shrinkage | | Shrinkage | MD | CD |
| No. | Composition | (%) | Composition | (%) | (%) | (%) |
| 1 | Standard | ~25 | Low Shrink | <11 | 26.5 | 8.3 |
| 2 | Standard | ~25 | Low Shrink | <11 | 27.2 | 8.7 |
| 3 | Standard | ~25 | Low Shrink | <11 | 24.5 | 9.5 |
| 4 | Standard | ~25 | Low Shrink | <11 | 24.0 | 9.8 |
| 5 | Standard | ~25 | Low Shrink | <11 | 27.6 | 9.8 |
| | | | | Ave= | 26.0 | 9.2 |

TABLE 5
Polymeric Sheet Samples 3

| | Tape | | | | | |
|---|---|---|---|---|---|---|
| | Machine Direction | | Cross Machine Direction | | Facer High | |
| | | Average | | Average | Temperature | |
| | | High | | High | Shrinkage | |
| | | Temp | | Temp | (%) | |
| | | Shrinkage | | Shrinkage | MD | CD |
| No. | Composition | (%) | Composition | (%) | (%) | (%) |
| 1 | Standard | ~25 | Low Shrink | <8 | 23.9 | 4.9 |
| 2 | Standard | ~25 | Low Shrink | <8 | 22.1 | 5.5 |
| 3 | Standard | ~25 | Low Shrink | <8 | 25.6 | 6.1 |
| 4 | Standard | ~25 | Low Shrink | <8 | 24.8 | 7.2 |
| 5 | Standard | ~25 | Low Shrink | <8 | 24.1 | 6.4 |
| | | | | Ave= | 24.1 | 6.0 |

The scope of the general inventive concepts are not intended to be limited to the particular exemplary embodiments shown and described herein. From the disclosure given, those skilled in the art will not only understand the general inventive concepts and their attendant advantages but will also find apparent various changes and modifications to the methods and systems disclosed. It is sought, therefore, to cover all such changes and modifications as fall within the spirit and scope of the general inventive concepts, as described and claimed herein, and any equivalents thereof.

1. A sheet material comprising:
a woven layer having a first side and an opposing second side, the woven layer comprising a polymeric strand comprising a polyolefin polymer and a nucleating agent;
a first polymeric coating disposed on the first side of the woven layer.

2. The sheet material of claim 1, wherein the sheet material includes a second polymeric coating disposed on the second side of the woven layer

3. The sheet material of claim 1, wherein the sheet material further comprises a mesh layer laminated to the first polymeric coating.

4. The sheet material of claim 3, wherein the mesh layer includes a plurality of first grid lines oriented in first direction and a plurality of second grid lines oriented in a second direction, and
wherein the first gridlines and the second gridlines form intersections that include peaks.

5. The sheet material of claim 1, wherein the sheet material further comprises a protective layer disposed on the first polymeric coating.

6. The sheet material of claim 1, wherein the sheet material further comprises a nonwoven layer disposed on the first polymeric coating.

7. The sheet material of claim 2, wherein the second polymeric coating includes an outer surface and the sheet material further comprises an adhesive on the surface of the second polymeric coating.

8. The sheet material of claim 7, wherein the adhesive is an asphalt-based adhesive.

9. The sheet material of claim 1, wherein the sheet material shrinks less than 10% in a linear direction when exposed to 150° C. for 10 minutes.

10. The sheet material of claim 1, wherein the sheet material shrinks less than 5% in a linear direction when exposed to 150° C. for 10 minutes.

11. The sheet material of claim 1, wherein the polyolefin polymer is polyethylene.

12. The sheet material of claim 1, wherein the polyolefin polymer is a high-density polyethylene.

13. The sheet material of claim 1, wherein the polyolefin polymer is a high-density polyethylene,
wherein the first polymeric composition includes a linear low-density polyethylene and a low-density polyethylene, and
wherein the second polymeric composition includes a linear low-density polyethylene and a low-density polyethylene.

14. The sheet material of any of claim 1, wherein the polyolefin polymer is a polypropylene polymer.

15. The sheet material of any of claim 1, wherein the polyolefin polymer is a polypropylene polymer,
wherein the first polymeric coating includes an inner polymeric layer including a polypropylene, a low density polyethylene, a filler, and a pigment; and
wherein the first polymeric coating includes an outer layer including polypropylene, low density polyethylene, a filler, a pigment, UV absorbers, and a hindered amine light stabilizer;
wherein the second polymeric coating includes an inner polymeric layer including a polypropylene, low density polyethylene, a filler, and a pigment; and
wherein the second polymeric coating includes an outer layer including polypropylene, low density polyethylene, a filler, a pigment, UV absorbers, and a hindered amine light stabilizer.

16. The sheet material of any of claim 1, wherein the polymeric strand further includes a filler.

17. The sheet material of any of claim 1, wherein the polymeric strand further includes a UV light stabilizer and/or UV absorber.

18. A sheet material comprising:
a woven layer having a first side and an opposing second side, the woven layer comprising a polymeric strand comprising a first polyethylene polymer and a nucleating agent;
a first polymeric coating comprising a second polyethylene disposed on the first side of the woven layer;
a second polymeric coating comprising a third polyethylene disposed on the second side of the woven layer; and
a protective layer disposed on the first polymeric coating.

19. A geomembrane installation comprising:
a first sheet material thermal bonded to a second sheet material;
wherein the first sheet material and the second sheet material each individual comprise:
a woven layer having a first side and an opposing second side, the woven layer comprising a polymeric strand comprising a polyolefin polymer and a nucleating agent;
a first polymeric coating disposed on the first side of the woven layer; and
a second polymeric coating disposed on the second side of the woven layer.

20-22. (canceled)
